(19) United States
(12) Patent Application Publication
(10) Pub. No.: US 2014/0193600 A1
(43) Pub. Date: Jul. 10, 2014

(54) Blind Slat Menders

(71) Applicant: Roy Kent Barudin, Lawrenceville, GA (US)

(72) Inventor: Roy Kent Barudin, Lawrenceville, GA (US)

(21) Appl. No.: 14/135,512

(22) Filed: Dec. 19, 2013

Related U.S. Application Data
(60) Provisional application No. 61/750,102, filed on Jan. 8, 2013.

(51) Int. Cl. C09J 7/04

(52) U.S. Cl. CPC C09J 7/04
USPC 428/41.7

(57) ABSTRACT

A new device that repairs a broken, cracked or bent wood or faux wood horizontal/venetian window blind slat or shutter slat. The device is a thin transparent square piece of enhanced extrusion lamination film with a clear adhesive on one side. Comprised of two different version types, one WITH and one WITHOUT a route hole (where the cord goes through on a window blind) on the film surface. A pliable slit on the version WITH a route hole allows the user to insert the blind cord running through the route hole into the die-cut oval area of the device so that it can be placed directly over the route hole on the blind slat to repair a blind slat damaged at the route hole. Both version types restore the damaged slat to its original functionality without having to totally replace the entire window blind or shutter or use unsightly tape, glue or a clamp.

### CROSS REFERENCE TO RELATED APPLICATIONS

This application claims the benefit of U.S. Provisional Application No. 61/750,102, filed Jan. 8, 2013, the disclosure of which is incorporated herein by reference.

### STATEMENT REGARDING FEDERALLY SPONSORED RESEARCH OR DEVELOPMENT

This invention was not created under a federally sponsored research or development contract.

### REFERENCE TO SEQUENCE LISTING, A TABLE, OR A COMPUTER PROGRAM LISTING COMPACT DISC APPENDIX

Not Applicable

### FIELD OF THE INVENTION

This invention relates to interior window blinds and shutters and more particularly pertains to the repair of horizontal/venetian wood and faux wood horizontal/venetian window blind slats and shutter slats that are broken, cracked or bent in any location on the slat.

### BACKGROUND OF THE INVENTION

According to the U.S. Consumer Products Safety Commission, 85 million horizontal blinds are sold each year. More than a few of the blind slats get damaged from either children playing in the house, or from the family pet jumping on them, or while the homeowner or commercial business building tenant or owner is trying to clean them.

The only repair options to date have been to take the time to remove the bottom rail plugs, pull out the cord, put in a new slat (if the manufacturer provided one), restring and re-plug. Alternatively, one could try to tape, glue or clamp the two broken pieces together but that doesn't repair the damaged slats very well and the window slat or shutter slat does not appear to be in an undamaged state. The final option is to purchase an entirely new blind, but the expense can be prohibitive.

There has not been a product available that homeowners, renters, blind/shutter installers, blind/shutter repairers, blind/shutter cleaners, blind/shutter retailers (bricks & mortar or online), blind/shutter manufacturers, blind/shutter wholesalers, blind/shutter distributors or commercial business building tenants or owners can purchase to repair the broken, cracked or bent horizontal/venetian wood or faux wood window blind slats or shutter slats.

This invention repairs broken, cracked or bent wood or faux wood horizontal/venetian window blind slats and shutter slats easily and saves homeowners, renters, window covering industry professionals and businesses, and commercial business building tenants and owners time and money with repair of their window coverings.

### SUMMARY OF THE INVENTION

The present invention repairs broken, cracked or bent wood or faux wood horizontal/venetian window blind slats and shutter slats.

The present invention is a time saving device because the user doesn't have to take down the damaged blinds off the window to repair them and provides a simple repair process for their damaged window coverings.

The present invention is a money saving device because the user doesn't have to purchase an entire new window blind; they can simply repair the damaged blind slat or shutter slat to make their blind slat look almost new again.

The components of the present invention may be made of a transparent (to repair any color blind slat or shutter slat), thin (so the user can barely see the device once applied), rigid and strong (to join together the damaged wood or faux wood slat pieces and appear to be undamaged and parallel to a person's view), glare-free (so the sun doesn't reflect off the device) and ultraviolet resistant (so the device won't yellow over time) enhanced extrusion lamination film (type of plastic) that is applied to the window blind slat or shutter slat via a clear adhesive on one side of the film.

The present invention joins together the damaged pieces of a broken or cracked slat, or straightens a bent slat, to make the slat look visually new again.

The present invention may be manufactured to be one size, and when applied to the damaged slats, fits the most commonly manufactured horizontal/venetian wood or faux wood blind slat and shutter slat widths which are presently two inches, two and three eighths inches and two and one half inches.

### DESCRIPTION OF THE DRAWINGS

### Present Invention without Route Hole

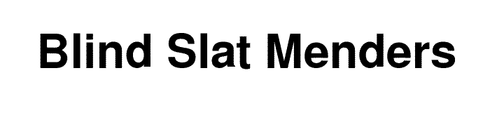

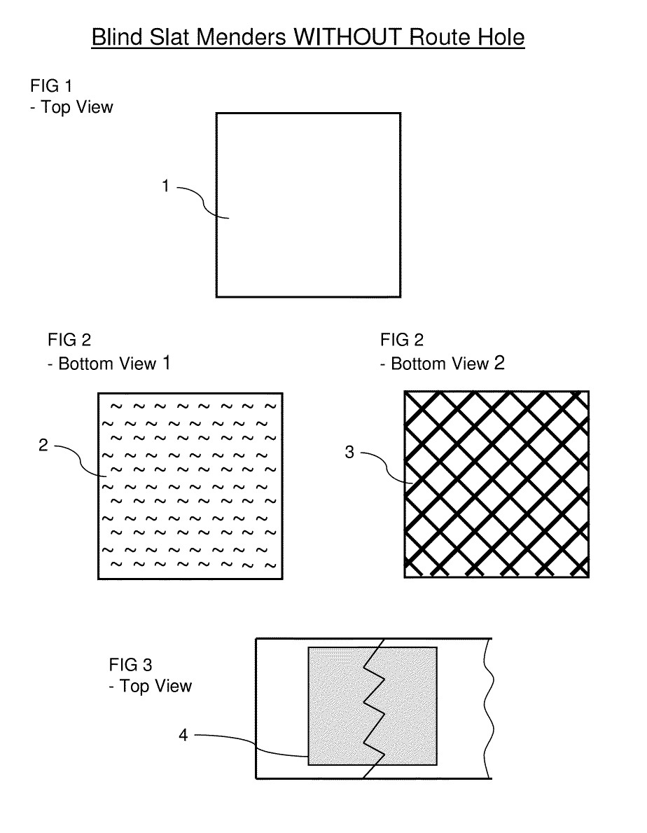

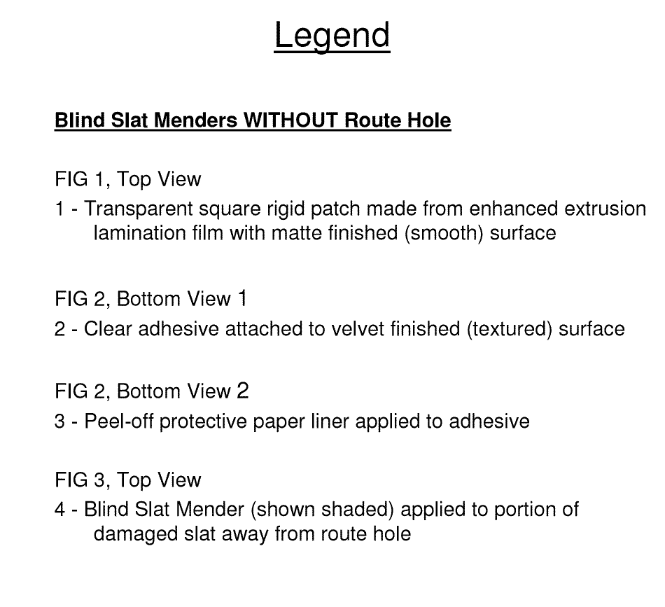

FIG. 1, Top View No. 1 depicts a transparent square rigid patch made from an enhanced extrusion lamination film with a matte finished (smooth) surface;

FIG. 2, Bottom View 1 No. 2 depicts a clear adhesive attached to velvet finished (textured) surface;

FIG. 2, Bottom View 2 No. 3 depicts the peel-off protective paper liner applied to the adhesive;

FIG. 3, Top View No. 4 depicts the Blind Slat Mender (shown shaded) applied to portion of damaged slat away from route hole.

### Present Invention with Route Hole

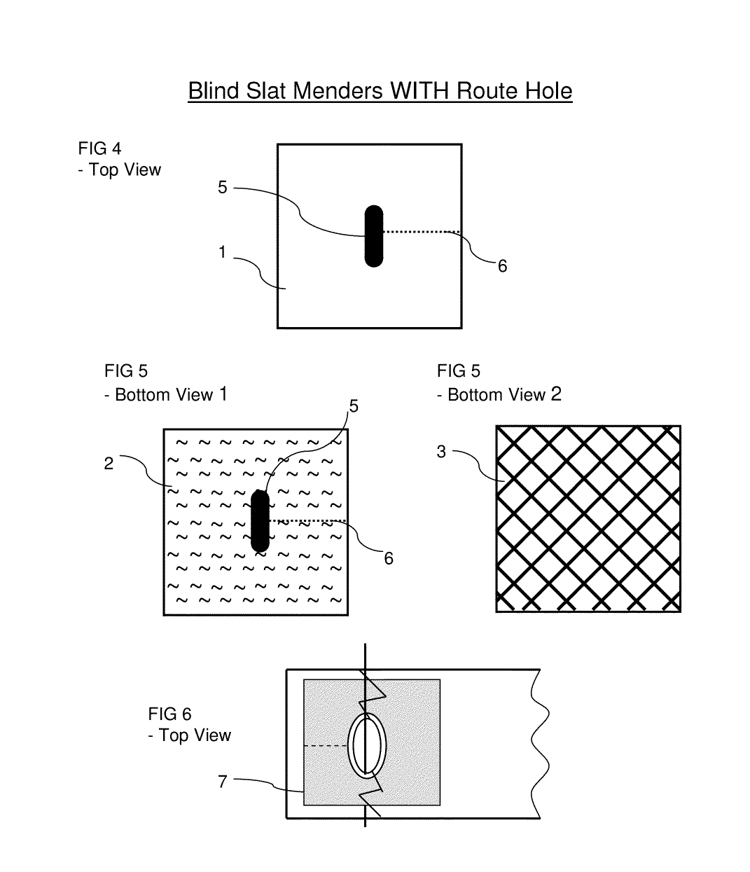

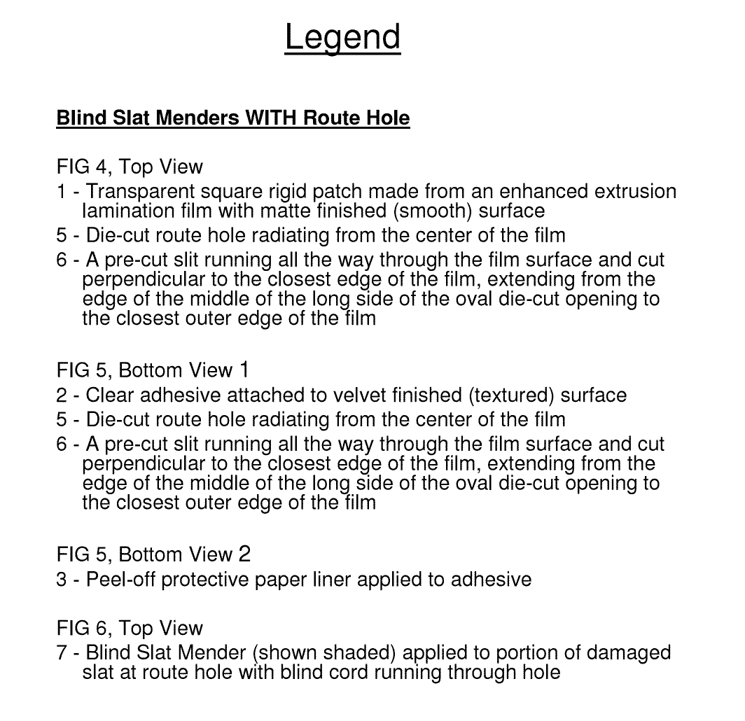

FIG. 4, Top View No. 1 depicts a transparent square rigid patch made from an enhanced extrusion lamination film with a matte finished (smooth) surface;

FIG. 4, Top View No. 5 depicts the die-cut route hole radiating from the center of the film;

FIG. 4, Top View No. 6 depicts the pre-cut slit running all the way through the film surface and cut perpendicular to the closest edge of the film, extending from the edge of the middle of the long side of the oval die-cut opening to the closest outer edge of the film;

FIG. 5, Bottom View 1 No. 2 depicts the clear adhesive attached to velvet finished (textured) surface;

FIG. 5, Bottom View 1 No. 5 depicts the die-cut route hole radiating from the center of film;

FIG. 5, Bottom View 1 No. 6 depicts the pre-cut slit running all the way through the film surface and cut perpendicular to the closest edge of the film, extending from the edge of the middle of the long side of the oval die-cut opening to the closest outer edge of the film;

FIG. 5, Bottom View 2 No. 3 depicts the peel-off protective paper liner applied to adhesive;

FIG. 6, Top View No. 7 depicts the Blind Slat Mender (shown shaded) applied to portion of a damaged slat at the route hole with blind cord running through hole.

### DETAILED DESCRIPTION OF THE INVENTION

The present invention is made from an enhanced extrusion lamination film with excellent scratch resistance and is also resistant to common household cleaners. Large sheets of the enhanced extrusion lamination film are die-cut to the pre-determined size of the invention.

The invention is made from a transparent (to repair any color blind slat), thin (so the user can barely see the device once applied), rigid and strong (to join together the damaged wood or faux wood window blind slat or shutter slat pieces and appear to be undamaged and parallel to a person's view), glare-free (so the sun doesn't reflect off the device when looking at the blind) and ultraviolet light resistant (so the device won't yellow over time) enhanced extrusion lamination film (plastic) that is applied to the window blind or shutter slats via a clear pressure sensitive adhesive attached to one side of the plastic material. A peel-off paper liner is attached to the adhesive to protect it until the invention is applied to the damaged slat.

The present invention is manufactured to be a pre-determined sized square and is slightly smaller than the most commonly manufactured window blind and shutter slat width which is presently two inches. In its current size, it is strong and effective enough to also be used to repair slats that are two and three eighths inches and two and one half inches wide.

When the present invention is applied to the slat it is meant to be laid equi-distant away from the leading and back edge of the slat in order to reinforce the invention's low profile appearance. Based on its size, if application directions are properly followed, it will not be applied even with the leading and back edge of the slat.

The present invention is manufactured in two version types (WITH a Route Hole and WITHOUT a Route Hole) for repairs to specific areas of a damaged blind or shutter slat.

The first version type of the present invention WITHOUT a Route Hole is used to repair broken, cracked or bent horizontal/venetian wood or faux wood window blind slat or shutter slat areas that are damaged more than one half inch away from the route hole opening (where the cord goes through on a blind) of the slat.

The second version type of the present invention WITH a Route Hole is used to repair broken, cracked or bent horizontal/venetian wood or faux wood window blind slat areas that are damaged within one half inch of the route hole opening (where the cord goes through on a blind) and has a die-cut elongated oval opening radiating from the center of the patch with a pre-cut slit pre-cut slit running all the way through the film surface and cut perpendicular to the closest edge of the film, extending from the edge of the middle of the long side of the oval die-cut opening to the closest outer edge of the film.

What is claimed is:

1. A device for repairing a broken, cracked or bent wood or faux wood horizontal/venetian window blind slat or shutter slat comprised of:
Two distinct version types of an enhanced extrusion lamination film that has a matte finish (smooth) on one side and a velvet (textured) finish on the second side containing the following properties:
(a) transparent
(b) glare-free
(c) ultraviolet light resistant
(d) scratch resistant
(e) thin
(1) Version type one is a die-cut square piece of lamination film WITHOUT a route hole (where the cord goes through on a window blind);
(a) the top side of the lamination film is a matte finish (smooth) with no die-cut areas on the surface of the film; and
(b) the bottom side of the lamination film is a velvet finish (textured) and contains a clear adhesive applied to the surface of the film with an attached peel-off protective paper liner to protect the adhesive until the device is applied to the damaged area of the slat.
(2) Version type two is a die-cut square piece of lamination film WITH a die-cut route hole (where the cord goes through on a window blind);
(a) the top side of the lamination film is a matte finish (smooth) with a die-cut oval shaped opening radiating from the center of the lamination film surface; and
(b) has a pre-cut slit running all the way through the film surface and cut perpendicular to the closest edge of the film, extending from the edge of the middle of the long side of the oval die-cut opening to the closest outer edge of the film; and
(c) the pre-cut slit is pliable without requiring any tools so that it can be separated by the user to insert the chord of the blind running through the route hole into the die-cut oval area of the device so that the device can be placed directly over the route hole on the blind slat to maximize its effectiveness in repairing the damaged blind slat; and
(d) the bottom side of the lamination film is a velvet finish (textured) and contains a clear adhesive applied to the surface with an attached peel-off paper protective liner to the adhesive until the device is applied to the damaged area of the slat.
